(19) United States
(12) Patent Application Publication
(10) Pub. No.: US 2011/0159344 A1
(43) Pub. Date: Jun. 30, 2011

(54) NON-AQUEOUS ELECTROLYTE SECONDARY CELL

(75) Inventors: Kazuma Kobayashi, Itano-gun (JP); Yohei Hirota, Itano-gun (JP); Yuki Morikawa, Sumoto-shi (JP); Yoshio Kato, Kobe-shi (JP); Yasuyuki Kusumoto, Kobe-shi (JP); Shigeki Matsuta, Kobe-shi (JP)

(73) Assignee: SANYO ELECTRIC CO., LTD., Osaka (JP)

(21) Appl. No.: 12/977,934

(22) Filed: Dec. 23, 2010

(30) Foreign Application Priority Data
Dec. 25, 2009 (JP) 2009-296245

(51) Int. Cl. H01M 2/16; H01M 2/18

(52) U.S. Cl. 429/130

(57) ABSTRACT

According to the invention, there can be provided a non-aqueous electrolyte secondary cell whose capacity is hardly decreased even stored at high temperatures in a charged state.

The non-aqueous electrolyte secondary cell uses an insulation adhesive tape composed of a base material and a glue material. And in an absorbance spectra of the glue material measured using an infrared spectrophotometer so that the maximum peak intensity is 5 to 20% in transmittance, when peak intensities for C—H stretching vibration of 3040 to 2835 cm⁻¹ and C═O stretching vibration of 1870 to 1560 cm⁻¹ are respectively defined as I(C—H) and I(C═O), a peak intensity ratio represented by I(C═O)/I(C—H) is 0.01 or less.

### BACKGROUND OF THE INVENTION

1. Field of the Invention

The present invention relates to an improvement of a non-aqueous electrolyte secondary cell.

2. Background Art

Today, mobile information terminals such as mobile phones and laptop computers have been rapidly enhanced in functionality and compactness and reduction in weight. As the driving power sources for these terminals, nonaqueous electrolyte secondary cells represented by lithium ion secondary cells, which have high energy density and high capacity, are widely used.

In particular, in the case of a nonaqueous electrolyte secondary cell using a spiral electrode assembly in which the strip-form positive and negative electrodes are wound spirally via a separator, since the area where the positive and negative electrodes face each other is large, high electric current can be easily taken out. For this reason, a non-aqueous electrolyte secondary cell using a spiral electrode assembly is widely used as a driving power of the above-mentioned mobile information terminal. For an equipment requiring high capacity, high current and high voltage, there has been used a battery pack in which multiple cells are connected in series and/or parallel.

A positive electrode for the spiral electrode assembly is fabricated by forming a layer of a positive electrode active material onto a foil-like core of the positive electrode. In addition, a positive electrode current collector tab for connection to a positive external terminal is attached to a core exposed portion where the layer of the positive electrode active material is not formed.

When the spiral electrode assembly is fabricated using the positive electrode to which the positive electrode current collector tab is attached, there has been a problem that an internal short circuit occurs because a burr of the positive electrode collector tab sticks out through a separator and thereby the positive electrode is brought in contact with the negative electrode. To solve this problem, it has been performed that an insulation adhesive tape is applied on the positive electrode collector tab to cover the burr. In addition, since a severe reaction may occur due to short circuit at the area where the core exposed portion of the positive electrode faces the negative electrode active material layer via the separator, an insulation adhesive tape is sometimes applied on the positive electrode in the above area.

As technologies regarding an insulation adhesive tape used in a non-aqueous electrolyte cell, the following patent documents 1 and 2 are included.
Patent Document 1: Japan Patent Application Publication No. 2003-132875
Patent Document 2: Japan Patent Application Publication No. 2006-286337

Patent Document 1 relates to a technology in which a positive electrode lead is covered with an adhesive tape without contacting with a electrode active material layer of a positive electrode plate. It also discloses that the adhesive tape is composed of a base material formed of a fluorine-based resin, at least one adhesive selected from natural rubber, isobutyl rubber and styrene-butadiene rubber, an organic component containing phthalocyanine, and a pigment selected from metal powder and an oxide of aluminum and titanium. According to this technique, it is stated to be possible to suppress a failure of cell voltage and a decrease in cell capacity due to a micro-short circuit.

Patent Document 2 relates to a technology in which a thin plate-like member comprising a base layer and a rubber resin layer is attached to an electrode assembly, and the thin plate-like member has functions of insulating or protecting the electrode assembly, or a function of preventing unwinding of the wound electrode assembly. According to this technology, it is stated that a cell with excellent cycle characteristics can be obtained even used at high voltage.

### SUMMARY OF THE INVENTION

However, when the inventors prepared lots of non-aqueous electrolyte secondary cells having the configuration of the patent document 1 and then the cells were stored at high temperature, it was found that there was a variation in voltage and remaining capacity of the cells after the storage. In addition, when a cell pack was formed by connecting multiple of such cells in series, and when variations in capacity occurs in even one cell of the cell pack, an overdischarge cell or an overcharge cell was generated in the cell pack, and thus performance of the cell pack was significantly decreased. The present inventors have investigated the cause of this defect and obtained the following finding. There is a cause due to an insulation tape used in the non-aqueous electrolyte secondary cell, and when the non-aqueous electrolyte secondary cell is stored at high temperatures, a by-product that adversely affects cell characteristics is deposited on a negative electrode active material or in micropores of a separator in the vicinity of the insulating tape applied on the positive electrode, and thereby storage characteristic of the cell is deteriorated. Further research carried out by the present inventors has revealed that certain functional groups contained in a glue material of the insulation adhesive tape are involved in side reaction in the cell.

Based on the above findings, the invention has been completed. And its object is to provide a nonaqueous electrolyte secondary cell using an insulating adhesive tape that prevents a side reaction adversely affecting cell performance.

The present invention for solving the above problems is characterized by a non-aqueous electrolyte secondary cell comprising an electrode assembly having a positive electrode and a negative electrode, and a nonaqueous electrolyte containing an electrolyte salt and a non-aqueous solvent, wherein: an insulation adhesive tape composed of a base material and a glue material containing a main agent with an adhesive function is applied on the positive electrode; and in an absorbance spectra of the glue material measured using an infrared spectrophotometer so that the maximum peak intensity is 5 to 20% in transmittance, when peak intensities for C—H stretching vibration of 3040 to 2835 cm⁻¹ and C═O stretching vibration of 1870 to 1560 cm⁻¹ are respectively defined as I(C—H) and I(C═O), a peak intensity ratio represented by I(C═O)/I(C—H) is 0.01 or less.

As a result of intensive studies by the present inventors, it has been revealed that a by-product is produced when the glue material constituting the insulating adhesive tape includes a carbon-oxygen double bond (carbonyl group). The mechanism is shown below.

When a positive electrode active material in a charged state reacts with the non-aqueous electrolyte, a cation radical is generated. This cation radical attacks a carbon-oxygen double bond contained in the glue material to produce an organic acid. This organic acid enhances elution of a transition metal (Co, Ni, Mn, etc.) contained in a lithium transition metal composite oxide that is the positive electrode active material, and thus the transition metal compound is deposited on the separator or the negative electrode in the vicinity of the insulation adhesive tape. This deposit is conductive and may cause micro-short circuit between the positive and negative electrodes.

In the above configuration of the present invention, regarding absorbance spectra of the glue material measured using an infrared spectrophotometer so that the maximum peak intensity is 5 to 20% in transmittance, when peak intensities attributed to C—H stretching vibration of 3040 to 2835 cm⁻¹ and C═O stretching vibration of 1870 to 1560 cm⁻¹ are respectively defined as I(C—H) and I(C═O), a peak intensity ratio represented by I(C═O)/I(C—H) is limited to 0.01 or less, which means that the glue material hardly includes a carbon-oxygen double bond (carbonyl group). Therefore, the above problem cannot occur. Consequently, storage characteristic of the cell stored in a charged state is dramatically improved.

The above problem does not occur when the insulating adhesive tape is applied on the negative electrode current collector tab or the outermost of the spiral electrode assembly in order to prevent an unwinding. In a word, the problem is specific to the application on the positive electrode.

This insulating adhesive tape is applied on a positive electrode current collector tab, or on the boundary between a positive electrode active material layer and a positive electrode core exposed portion.

The glue material contains a main agent with an adhesive function as an essential component, while it may also contain pigments for coloring or other additives.

In the above configuration, the positive electrode has the positive electrode active material layer formed on the positive electrode core, and has the core exposed portion where the positive electrode active material layer is not formed on the positive electrode core. The insulating adhesive tape is applied so as to cover the core exposed portion and a part of the positive electrode active material layer. Preferably, the positive electrode current collector tab is attached to the core exposed portion, and the insulation adhesive tape is applied so as to cover the core exposed portion, a part of the positive electrode active material layer, and an overlapped area of the positive electrode current collector tab with the core exposed portion.

According to this configuration, in the area where the insulation adhesive tape is applied so as to cover the positive electrode active material layer, the main agent of the insulation adhesive tape is directly contacted with the positive electrode active material layer, and therefore the effect of the present invention is significantly obtained. In addition, when the positive electrode collector tab is covered with the insulation adhesive tape, it is possible to prevent the occurrence of internal short circuit due to a burr.

As the above base material of the insulation adhesive tape, it is preferable to use at least one selected from the group consisting of polyimide, polypropylene, polyphenylene sulfide, polyether ether ketone, and polyethylene naphthalate.

As the main agent of the insulation adhesive tape, rubber is preferably used. More preferably, butyl rubber is used.

In the above configuration, the positive electrode active material contained in the positive electrode active material layer can be configured so as to comprise a lithium transition metal composite oxide represented by LiₐM_{1-b}X_{b}O₂ (M is at least one of Co, Ni and Mn; X is at least one of Ti, Zr, Mg, Al and Sn; 0<a≦1.1; and 0≦b≦0.03).

As stated above, according to the configuration of the present invention, since elution of the transition metal from the positive electrode active material is prevented, when a compound represented by the above formula is used as the positive electrode active material, there can be realized a nonaqueous electrolyte cell with no possibility of the elution of transition metals.

### BRIEF DESCRIPTION OF DRAWINGS

FIG. 1 shows a perspective view of a dismantled cross-sectional area in the cell of the present invention.

FIG. 2 is a diagram showing the positive electrode used in the present invention.

FIG. 3 is a diagram showing an infrared absorption spectrum of Tape 1.

FIG. 4 is a diagram showing an infrared absorption spectrum of Tape 2.

FIG. 5 is a diagram showing an infrared absorption spectrum of Tape 3.

FIG. 6 is a graph showing a relationship between I(C═O)/I(C—H) and variation of the remaining capacity after 30 days storage.

FIG. 7 is a diagram showing a modified example of a position where the core exposed portion is formed in the positive electrode used in the present invention.

FIG. 8 shows a modified example of a position where the insulation adhesive tape is applied in the positive electrode used in the present invention.

### DESCRIPTION OF THE CODE

1 Outer can
2 Electrode assembly
3 Positive electrode
3a Positive electrode current collector tab
3b, 3c Core exposed portion
3d Positive electrode active material layer
3e Insulation adhesive tape
4 Negative electrode
4a Negative electrode collector tab
5 Separator
6 Sealing body

### DETAILED DESCRIPTION OF THE INVENTION

Embodiment for carrying out the present invention will be described in detail using the drawings. The invention is not intended to be limited to the following Embodiment, and it is possible to implement appropriate changes within a range not changing the gist thereof.

### Embodiment

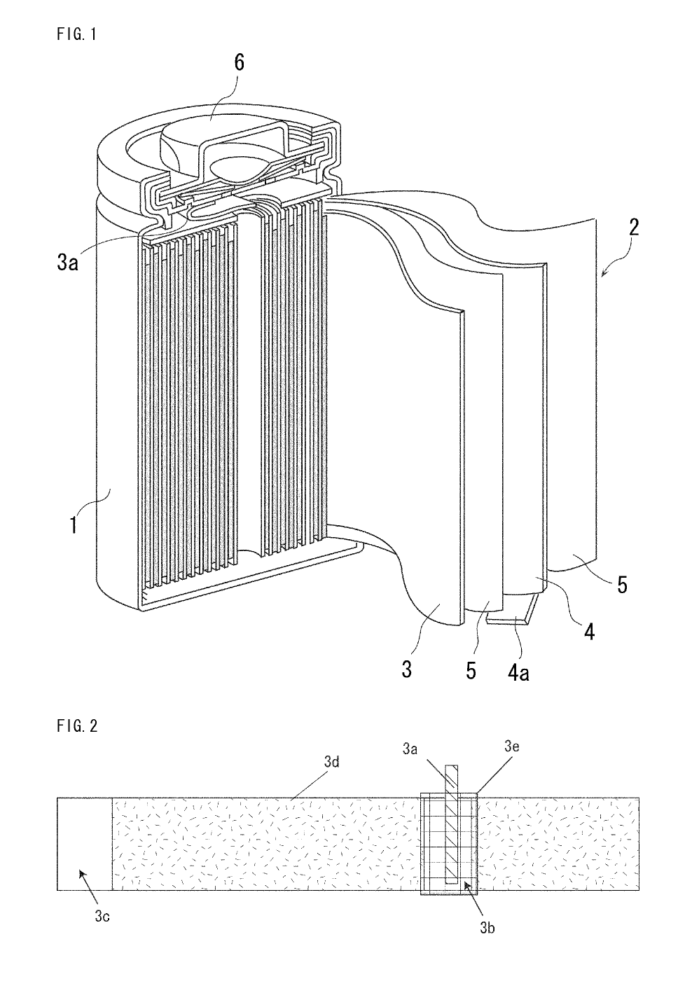

With reference to FIG. 1, the cell according to Embodiment is explained. FIG. 1 shows a perspective view of a dismantled cross-sectional area in the cell of the present invention, and FIG. 2 is a diagram showing the positive electrode where the positive electrode current collector tab is attached and the insulation adhesive tape is applied.

As shown in FIG. 1, in the cell according to the invention, an electrode assembly 2 comprising a separator 5, a positive electrode 3 and a negative electrode 4 is inserted into a cylindrical outer can 1. The opening of the outer can 1 is sealed by a sealing body 6. A negative electrode 4 is electrically connected to the outer can 1 via a negative electrode current collector tab 4a, while a positive electrode 3 is electrically connected to the sealing body 6 via a positive electrode current collector tab 3a. In a word, the outer can 1 also serves as a negative external terminal, and the sealing body 6 also serves as a positive external terminal. In addition, a non-aqueous electrolyte containing an electrolyte salt and a non-aqueous solvent is injected into the outer can 1.

As shown in FIG. 2, the positive electrode 3 has a configuration in which a positive electrode active material layer 3d is formed on a positive electrode core. At one end and a middle part of the positive electrode core, there are provided core exposed portions 3b and 3c on which the positive electrode active material layer 3d is not formed. In addition, a positive electrode collector tab 3a is attached to the core exposed portion 3b of the middle part. And an insulation adhesive tape 3e is applied so as to cover the core exposed portion 3b, a part of the positive electrode active material layer 3d, and an overlapped portion of the positive electrode current collector tab 3a with the core exposed portion 3b.

Next, the present invention is described in more detail using Examples.

### <Insulation Adhesive Tape>

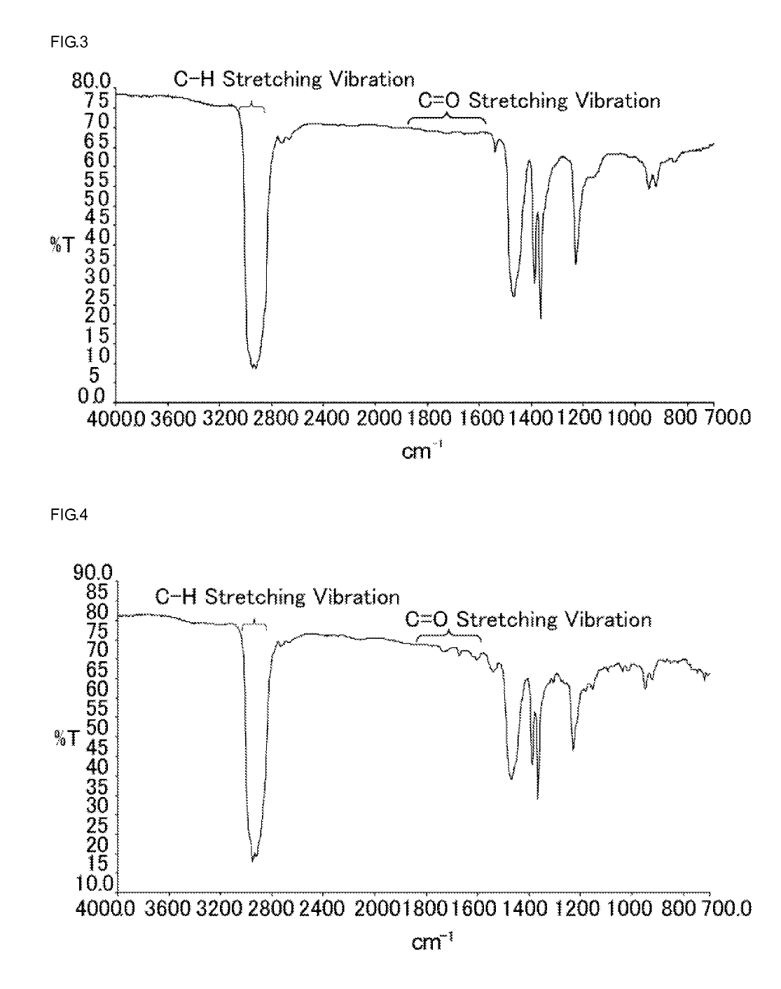

There was prepared insulation adhesive tapes 1 to 3 comprising a base material made of polyimide, and a glue material in which a pigment, an additive and the like are added to a main agent made of butyl rubber having an adhesive function. Absorbance spectra of the glue material of the insulation adhesive tapes 1 to 3 were measured using an infrared spectrophotometer (Spectrum-One+Auto IMAGE, manufactured by PerkinElmer Japan) so that the maximum peak intensity was 5 to 20%. These results are shown in FIGS. 3 to 5. In the tapes 1 to 3, each of pigments contained in the glue material was different from one another.

In these absorbance spectra, a peak intensity attributed to C—H stretching vibration of 3040 to 2835 cm⁻¹ was defined as I(C—H), and a peak intensity attributed to C═O stretching vibration of 1870 to 1560 cm⁻¹ was defined as I(C═O), and then I(C═O) and a peak intensity ratio represented by I(C═O)/I(C—H) were calculated. The results are shown in Table 1 below.

TABLE 1

| | Maximum Peak Intensity (%) | I(C═O)/I(C—H) | I(C═O) |
|---|---|---|---|
| Tape 1 | 10 | 0.01 | 0.01 |
| Tape 2 | 18 | 0.02 | 0.02 |
| Tape 3 | 10 | 0.05 | 0.05 |

From Table 1 and FIGS. 3 to 5, it is found that both the peak intensity I(C═O) and the peak intensity ratio I(C═O)/I(C—H) have the relationship of Tape 1<Tape 2<Tape 3.

Using these insulating adhesive tapes 1 to 3, non-aqueous electrolyte secondary cells according to Example 1 and Comparative Examples 1 and 2 were assembled by the methods described below. In addition, without using the insulation adhesive tape, a non-aqueous electrolyte secondary cell according to Reference Example 1 was assembled.

### Example 1

### Preparation of Positive Electrode

Lithium cobalt composite oxide as a positive electrode active material, acetylene black as a conductive agent and polyvinylidene fluoride as a binder were mixed in a mass ratio of 90:5:5. Then, the resulting mixture was dispersed in N-methylpyrrolidone as a solvent to form a positive electrode active material slurry. This slurry was applied on a positive electrode core made of aluminum foil with 15 μm thickness to prepare a positive electrode active material layer 3d including core exposed portions 3b and 3c. Thereafter, the resulting product was dried, rolled and cut to a desired size. Then, a positive electrode collector tab 3a was attached to the core exposed portion 3b of the middle portion, and further the above Tape 1 as an insulation adhesive tape 3e was applied on the positive electrode collector tab as shown in FIG. 2, thus preparing a positive electrode 3. This insulating tape was 2.7 mm higher and 2.5 mm wider than the core exposed portion 3b, and a base material with 25 μm thickness was used.

### <Preparation of the Negative Electrode>

Graphite powder as a negative electrode active material, carboxymethyl cellulose as a thickening agent and styrene butadiene rubber as a binder were mixed in a mass ratio of 95:3:2. Then, the resulting mixture was dispersed in water as a solvent to form a negative electrode active material slurry. This slurry was applied on a negative electrode core made of a copper foil with 8 μm thickness to prepare a negative electrode active material layer including a core exposed portion. Thereafter, the resulting product was dried, rolled and cut to a desired size. Then, a negative electrode collector tab 4a was attached to the core exposed portion, thus preparing the negative electrode 4.

### <Preparation of Non-Aqueous Electrolyte>

LiPF₆ as a solute was dissolved with a concentration of 1.0 M (mol/l) in a solvent mixture in which ethylene carbonate, propylene carbonate and dimethyl carbonate were mixed in a volume ratio of 25:5:70 (at 1 atm and 25° C.).

### <Preparation of Electrode Assembly>

The positive electrode 3 and the negative electrode 4 were wound in a spiral form via a separator made of a polyethylene microporous film to prepare an electrode assembly.

### <Cell Assembly>

The above electrode assembly was insert to a cylindrical outer can. After the negative electrode current collector tab 4a was connected to a bottom of the outer can, a positive electrode collector tab 3a was connected to the sealing body and the non-aqueous electrolyte was injected. Thereafter, an opening of the cylindrical outer can was sealed by swaging a sealing body 6 via a gasket to fabricate a non-aqueous electrolyte secondary cell according to Example 1 having a cell size (diameter) of 18 mm and a height of 65 mm.

### Comparative Example 1

A non-aqueous electrolyte secondary cell according to Comparative Example 1 was fabricated in the similar way to Example 1 except that above Tape 2 was used as the insulating adhesive tape.

### Comparative Example 2

A non-aqueous electrolyte secondary cell according to Comparative Example 2 was fabricated in the similar way to Example 1 except that above Tape 3 was used as the insulating adhesive tape.

### Reference Example 1

A non-aqueous electrolyte secondary cell according to Reference Example 1 was fabricated in a similar way to Example 1 except that the insulating adhesive tape was not applied.

### (Storage Test in Charged State)

For each of Example 1, Comparative Examples 1 and 2, and Reference Example 1, two hundred non-aqueous electrolyte secondary cells were fabricated. Next, these cells were charged at a constant current of 0.7 It (1750 mA) to a voltage of 4.2V, and then charged at a constant voltage to a current of 0.02 It (50 mA). Then, the voltages of these cells were measured at 25° C. Thereafter, these cells were discharged at a constant current of 1.0 It (2500 mA) to a voltage to 3.0V, and the discharge capacity in this point (initial capacity) was measured.

Thereafter, these cells were charged at a constant current of 0.7 It (1750 mA) to a voltage of 4.2V, and then charged at a constant voltage to a current of 0.02 It (50 mA). After this, half of the cells (100 each) were stored for 7 days in a thermostatic bath at 60° C., while the other half of the cells (100 each) were stored for 30 days in a thermostatic bath at 60° C. The cells after the storage were cooled to 25° C., and then each voltage of the cells was measured. Thereafter, the cells were discharged at a constant current of 1.0 It (2500 mA) to a voltage of 3.0V, and then discharge capacity (remaining capacity) was measured. Thereafter, the cells were charged at a constant current of 0.7 It (1750 mA) to a voltage of 4.2V, and then charged at a constant voltage to a current of 0.02 It (50 mA), and were again discharged at a constant current of 1.0 It (2500 mA) to voltage of 3.0V. Then, the discharge capacity at this point (recovery capacity) was measured.

And, the remaining capacity ratio and recovery capacity rate were calculated using the following formulas. The results are showed in following Tables 2 and 3.

Remaining capacity ratio (%)=Remaining capacity÷Initial capacity×100

Recovery capacity rate (%)=Recovery capacity÷Initial capacity×100

TABLE 2
Charged Storage for 7 days

| | Variation | | Variation | |
|---|---|---|---|---|
| | width of | Remaining | width of | Recovery |
| | Voltage after | capacity ratio | Remaining | capacity rate |
| | storage | (Average) | capacity | (Average) |
| | (V) | (%) | (%) | (%) |
| Example 1 | 0.001 | 93.6 | 0.2 | 98.1 |
| Comparative | 0.008 | 92.9 | 1.3 | 98.0 |
| example 1 | | | | |
| Comparative | 0.013 | 91.3 | 1.9 | 97.9 |
| example 2 | | | | |
| Reference | 0.001 | 93.6 | 0.2 | 98.1 |
| example 1 | | | | |

TABLE 3
Charged Storage for 30 days

| | Variation | | Variation | |
|---|---|---|---|---|
| | width of | Remaining | width of | Recovery |
| | Voltage after | capacity ratio | Remaining | capacity rate |
| | storage | (Average) | capacity | (Average) |
| | (V) | (%) | (%) | (%) |
| Example 1 | 0.004 | 90.1 | 0.4 | 93.1 |
| Comparative | 0.075 | 85.0 | 8.0 | 93.0 |
| example 1 | | | | |
| Comparative | 0.252 | 78.0 | 26.0 | 92.8 |
| example 2 | | | | |
| Reference | 0.004 | 90.2 | 0.4 | 93.2 |
| example 1 | | | | |

In above Tables 2 and 3, the variation width of voltage after storage means the difference (V) between maximum and minimum of voltage of the cells after storage (100 each), and the variation width of the remaining capacity means the ratio of the difference between maximum and minimum of the remaining capacity to the initial capacity.

From above Table 2 and 3, it is found that all of Example 1, Comparative Examples 1 and 2, and Reference Example 1 have the following features: in the case of the 30 days storage, the variation width of voltage after storage and the variation width of the remaining capacity are larger, and the remaining capacity ratio and the recovery capacity rate are smaller, compared with the case of the 7 days storage.

Based on the above results, it may be thought that side reaction adversely affecting the performance of cells proceeds with time of the high-temperature storage with charge.

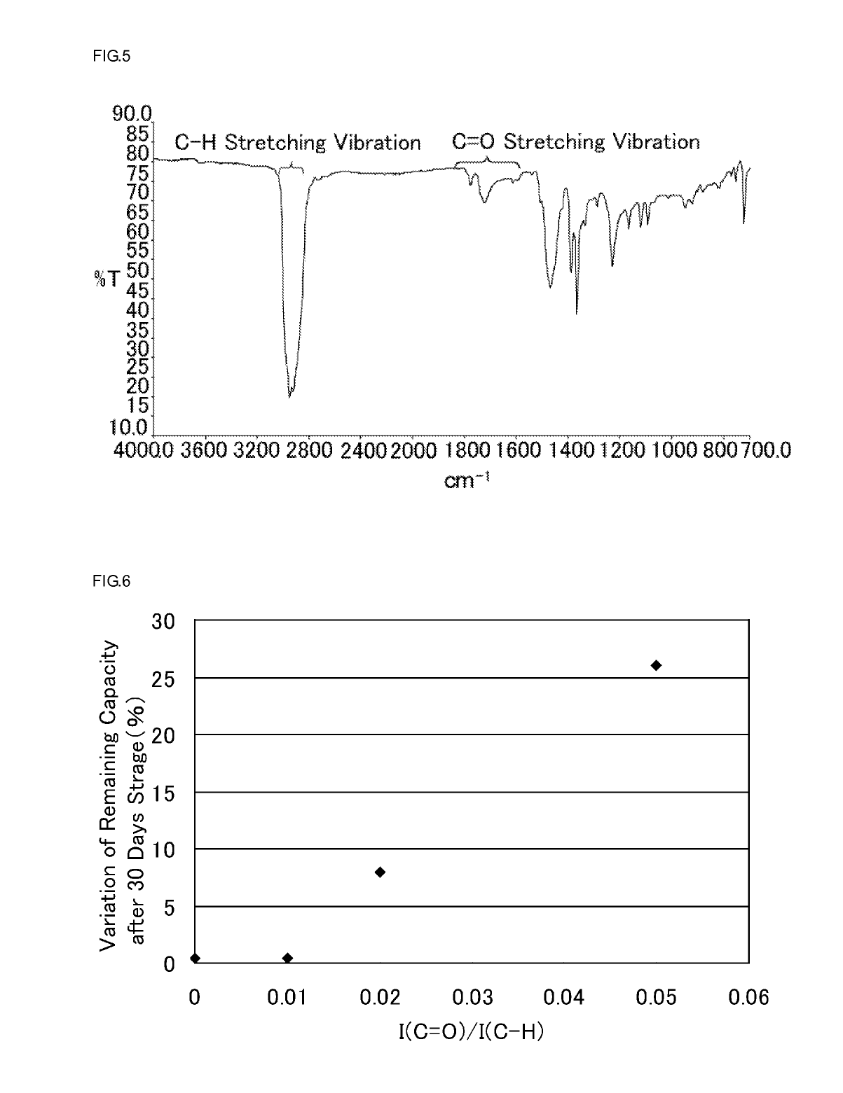

FIG. 6 shows the relationship between the variations width of capacity remaining after 30 days storage and the peak intensity ratio of the glue material, I(C═O)/I(C—H), in Example 1, Comparative Example 1 and 2, and Reference Example 1. However, since the tape is not used in Reference Example 1, its ratio I(C═O)/I(C—H) is plotted as 0 in FIG. 6. In FIG. 6, the variation width of the remaining capacity linearly increases in the range of I(C═O)/I(C—H) from 0.1 to 0.5, while there is little change in the variation width of the remaining capacity in the range of I(C═O)/I(C—H) from 0 to 0.1 (Example 1 using Tape 1, and Reference Example 1 not using the tape).

This can be explained as follows. The increase of the peak intensity ratio I(C═O)/I(C—H) means an increase in carbon-oxygen double bonds contained in the glue material. When the charged positive electrode active material reacts with the non-aqueous electrolyte, a cation radical is generated. This cation radical attacks the carbon-oxygen double bond contained in the glue material to produce an organic acid. This organic acid enhances elution of a transition metal (Co, Ni, Mn, etc.) contained in the lithium transition metal composite oxide as the positive electrode active material. Thereby, a transition metal compound is deposited on the separator or the negative electrode in the vicinity of the insulation adhesive tape, and a micro-short circuit thus occurs between the positive and negative electrodes. The increase in carbon-oxygen double bonds tends to enhance the above reaction, the remaining capacity is easily decreased, and thus the variation width of the remaining capacity is increased. In contrast, when the peak intensity ratio I(C═O)/I(C—H) is 0.01 or less, since the carbon-oxygen double bond is hardly contained, the above-mentioned problem does not occur.

In view of the above, it is found that the peak intensity ratio I(C═O)/I(C—H) of 0.01 or less provides storage characteristics almost as excellent as the case without the tape. In the case without tape, as stated above, a short circuit due to a burr may occur, and therefore it is preferable to use an insulating tape whose peak intensity ratio I(C═O)/I(C—H) is limited to 0.01 or less. In addition, it is preferable to lower the peak intensity I(C═O) indicating the amount of the carbon-oxygen double bond contained in glue material, and thus to limit the peak intensity I(C═O) to 0.01 or less.

### (Supplementary Remarks)

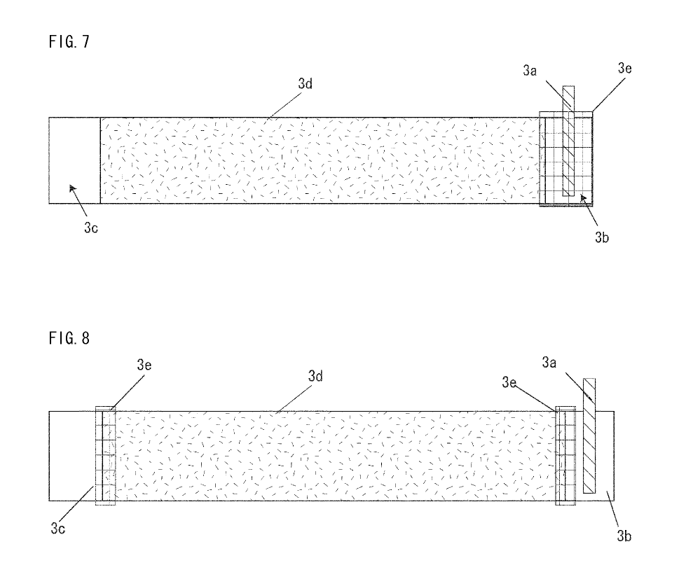

Above Examples are described using an example in which the core exposed portions 3c is provided at one end and the other core exposed portion 3b is provided at the intermediate part. However, the present invention is not limited to such a configuration. For example, as shown in FIG. 7, a configuration may be used in which the positive electrode core exposed portion is provided at both ends.

In addition, above Examples are described using the example in which the insulation adhesive tape 3e is applied so as to cover the core exposed portion 3b, a part of the positive electrode active material layer 3d, and a overlapped area of the core exposed portion 3b with the positive electrode current collector tab 3a. However, the present invention is not limited to such a configuration. For example, as shown in FIG. 8, the insulation adhesive tape 3e may be applied so as to cover the boundary between the positive electrode active material layer 3d and the core exposed portion 3b or 3c.

The size of the insulating adhesive tape may be appropriately set depending on a position where the tape is applied and a material used as a base material of the tape, etc.

As described above, according to the invention, there can be provided a non-aqueous electrolyte secondary cell in which a decrease in capacity is small even stored in a charged state and a short circuit due to a burr hardly occurs. Thus, the industrial applicability of the present invention is significant.

What is claimed is:

1. A non-aqueous electrolyte secondary cell comprising:
an electrode assembly having a positive electrode and a negative electrode; and
a nonaqueous electrolyte containing an electrolyte salt and a non-aqueous solvent,
wherein:
an insulation adhesive tape composed of a base material and a glue material containing a main agent with an adhesive function is applied on the positive electrode; and
in an absorbance spectrum of the glue material measured using an infrared spectrophotometer so that the maximum peak intensity is 5 to 20% in transmittance, when peak intensities for C—H stretching vibration of 3040 to 2835 cm⁻¹ and C═O stretching vibration of 1870 to 1560 cm⁻¹ are respectively defined as I(C—H) and I(C═O), a peak intensity ratio represented by I(C═O)/I(C—H) is 0.01 or less.

2. The non-aqueous electrolyte secondary cell according to claim 1, wherein:
the positive electrode has a positive electrode active material layer formed on a positive electrode core, and has a core exposed portion where the positive electrode active material layer is not formed on the positive electrode core; and
the insulating adhesive tape is applied so as to cover the core exposed portion and a part of the positive electrode active material layer.

3. The non-aqueous electrolyte secondary cell according to claim 2, wherein:
a positive electrode current collector tab is attached to the core exposed portion; and
the insulation adhesive tape is applied so as to cover the core exposed portion, a part of the positive electrode active material layer, and an overlapped area of the positive electrode current collector tab with the core exposed portion.

4. The non-aqueous electrolyte secondary cell according to claim 1, wherein the base material of the insulation adhesive tape is at least one selected from the group consisting of polyimide, polypropylene, polyphenylene sulfide, polyether ether ketone, and polyethylene naphthalate.

5. The non-aqueous electrolyte secondary cell according to claim 1, wherein the main agent of the insulation adhesive tape comprises rubber.

6. The non-aqueous electrolyte secondary cell according to claim 5, wherein the main agent of the insulation adhesive tape comprises butyl rubber.

7. The non-aqueous electrolyte secondary cell according to claim 2, wherein a positive electrode active material contained in the positive electrode active material layer comprises a lithium transition metal composite oxide represented by LiₐM_{1-b}X_{b}O₂ (M is at least one of Co, Ni and Mn; X is at least one of Ti, Zr, Mg, Al and Sn; 0<a≦1.1; and 0≦b≦0.03).

8. The non-aqueous electrolyte secondary cell according to claim 1, wherein the glue material contains a component other than the main agent with an adhesive function.

9. The non-aqueous electrolyte secondary cell according to claim 8, wherein the component other than the main agent with an adhesive function is a pigment.
